(19) United States
(12) Patent Application Publication
(10) Pub. No.: US 2021/0262471 A1
(43) Pub. Date: Aug. 26, 2021

(54) PTO DRIVEN ARTICULATED TRAILER TURBINE PUMP

(71) Applicant: Harrinarine Ramlall, Clarksburg, MD (US)

(72) Inventor: Harrinarine Ramlall, Clarksburg, MD (US)

(21) Appl. No.: 17/302,642

(22) Filed: May 7, 2021

(51) Int. Cl. F04D 13/02; F04D 29/60

(52) U.S. Cl. CPC F04D 13/021; F04D 29/605

(57) ABSTRACT

The presented trailer pump includes a pump housing an inlet, an outlet, an impeller with a vaned diffuser, a hydraulically or manually controlled articulated universal joint configured on a drive shaft, a pivotal joint configured on an elongated frame. The universal joint and pivotal connections helps in angular adjustability of the drive shaft and the frame simultaneously. The trailer pump further includes an articulated delivery pipe connected to the outlet. The delivery pipe is configured to have multi-directional movement. The trailer pump includes an adjustable hitch tongue that can be selectively adjusted based on an angle at angulated frame or drive shaft, and a dual function jack stand and chock used to keep the trailer pump at definite height above ground when the trailer is parked, for easy coupling of tractor's hitch to the hitch tongue and to assist in resisting backward/downward rolling motion of the tractor and the pump.

### TECHNICAL FIELD OF INVENTION

The present invention generally relates to turbine pumps, more particular to a power take-off (PTO) driven articulated trailered turbine pump that can be used in irrigation, flood control and various other uses where a high volume of material (such as water, slurry) needs to be moved/pumped from a source (such as canals, ditches, rivers, ponds) to another desired location.

### BACKGROUND

Portable irrigation and water pump devices or mobile pumps have been used in the past that are adaptable to trucks and tractors and connectable to a power take-off of the trucks and tractors. Mobile pump systems are well known and used for pumping water from one location to another. These systems usually include an internal combustion engine mounted on a suitable carriage. These systems generally include an elongated conduit or discharge tube with a pump or motor mounted within the tube. In order to be capable of operation at various water levels, prior art mobile pump systems have used complex winch and pulley systems to adjust the angle at which the discharge tube is placed in the water. Examples of typical prior art mobile pump systems which use these complex pulley and winch systems include U.S. Pat. Nos. 3,008,422 and 4,070,135.

Many other designs for trailer turbine/centrifugal pumps have been visualized by inventors in the past: U.S. Pat. No. 4,175,916 discloses about a portable trailer pump of the centrifugal type. The trailer pump can be towed behind a tractor and backed into and submerged or partially submerged in the material being pumped with an impeller of the pump being driven from the tractor power take-off. This patent discloses a steep-angle hitch comprising three longitudinally extending frame members which are in the form of hollow tubular members and oriented to define a triangular cross-sectional arrangement. Each of these frame members includes a rearward portion and a forward portion. The rearward portions of the two side frame members are angulated with respect to the their forward portions with a juncture there between being located in a position above the remote ends of the side frame members so that the included angle between the rearward portions and the forward portions of the two side members is an obtuse angle generally conforming the frame members with the ground surface, the ditch bank or wall and the edge thereof.

U.S. Pat. No. 5,364,233 discloses about an improved irrigation pump that includes an elongated frame that can have trailer wheels at one end portion, and a trailer tongue at the opposite end portion for connection to a tractor. The wheeled end portion includes a housing having an impeller driven by rotary power from the tractor, and wherein an improved configuration of the housing and impeller provide increased efficiency (80-90%).

CN203750075 discloses about a trailer type pump system that can be towed by a truck. The patent in particular discloses about a portable fire water pumping equipment that directly absorb water from open water supply and then delivers to desired area.

U.S. Pat. No. 5,100,303 discloses an easily transportable agitator and pump assembly which can be easily maneuvered by a conventional farm tractor and can be transported over roads by being trailed behind a light vehicle. The pump assembly includes pump housing at the end of an elongated frame supported on a wheeled sub-frame. The wheeled sub-frame is pivotally connected near one end to a midpoint of the elongated frame. The pump housing includes a rotating bladed impeller having an axis of rotation which is at an acute angle to the elongated frame, and a screw pump extends above the housing for thrusting the material downwardly through the housing upon rotation thereof.

VENERONI^{R} ATS (https://www.veneroni.it/) is another mobile pump in the same space. ATS pump is a tractor driven centrifugal pump with hydraulic rotation. ATS pumps are hoisted off ground via tractor's 3-point hydraulic hitch system. This mobile pump grants high modulability when pumping and great flexibility of use. The hydraulically adjustable delivery pipe with a hydraulic telescopic pipe extensible grants the best adaptability, suiting with precision to the different working configurations. Veneroni's ATS pumps are hoisted via 3-point hitch for transportation instead of being pulled on wheels. This may be disadvantageous on two fronts: 1) it increase turning radius of tractor and the hoisted pump as it is constrained horizontally at 3-point hitch connection and adds to total solid length of moving machine and equipment, and 2) the length and weight of the hoisted pump act as a loaded lever at rear and reduces traction of tractor's front steering wheels during transport.

Despite the existence of aforementioned and many other mobile pumps power take-off driven trailered turbine pump, one or more problems in these mobile pumps or water pump devices still exist. For example, existed mobile pumps require complex rigging and doesn't provide the precise degree of control and easy operability that is desired, some of these power take-off driven trailered turbine pumps doesn't provide proper impeller efficiency, lack proper angular flexibility over embankments and river bed slopes for submersing the pump housing into the sumps, ponds, rivers or other sources from where the fluid needs to be pumped out and so on.

### BRIEF SUMMARY

Before the present systems and methods, enablement are described, it is to be understood that this application is not limited to the particular systems, and methodologies described, as there can be multiple possible embodiments which are not expressly illustrated in the present disclosures. It is also to be understood that the terminology used in the description is for the purpose of describing the particular versions or embodiments only, and is not intended to limit the scope of the present application.

It is an objective of the present invention to provide a portable PTO driven turbine or centrifugal trailer pump which can be operated in deep ditches, sumps, concrete canals, ponds or the like sources and be used in irrigation, flood control, reclamation, aquaculture, sewage treatment and various other uses where a high volume pumping can be effectively utilized.

It is an objective of the present invention to provide a PTO driven trailer turbine or centrifugal trailer pump that is portable, partially or fully submersible in the source of material to be pumped out.

It is another objective of the present invention to provide an easily transportable trailer pump. The trailer pump can be easily engaged to or disengaged from a conventional farm tractor.

It is another objective of the present invention to provide a portable trailer pump that can be carried on by some light vehicles, if required.

It is another objective of the present invention to provide a PTO driven trailer turbine pump that uses a mixed flow impeller with a vaned diffuser. The mixed flow impeller with a vaned diffuser provides a wider range of flow rates and pressures for the fluid passing there-through.

It is another objective of the present invention to provide a PTO driven trailer turbine pump with a hydraulically or manually controlled articulated mid joint (i.e. universal joint) configured on a drive shaft connecting impeller and the power take-off unit on the tractor to allow angular flexibility for varying embankments and river beds and for partially or fully submersing the pump housing into the sumps, ponds or other sources from where the fluid needs to be pumped out.

It is another objective of the present invention to provide a PTO driven trailer turbine pump with an articulated delivery pipe/tube for multi-directional discharge of the fluid. This is facilitated by a stabilizer arm with adjustable length that can be hydraulically or manually controlled in order to swing the delivery pipe in multi-direction and push or pull the discharge pipe away or closer to the frame, respectively.

It is another objective of the present invention to provide a PTO driven trailer turbine pump with an adjustable hitch tongue that can be selectively adjusted based on the angle at angulated frame or drive shaft. The adjustment of the hitch tongue may be helpful while the trailer pump maneuver embankments/river beds or the trailer pump is connected to the tractor for transportation. The operator (operator of the pump or the driver of the tractor) can choose to keep angular adjustments at the articulated mid joint (i.e. universal joint) configured on the drive shaft and the hitch tongue if such setting is repetitively used.

It is another objective of the present invention to provide a PTO driven trailer turbine pump with a dual function jack stand and chock. The jack stand is usually used to keep the pump or trailer at definite height above ground when the trailer is parked and for easy coupling of tractor's hitch to the adjustable hitch tongue of the pump. Additionally, unlike the existing systems, the chock of the proposed trailer pump assists in resisting backward motion or rolling of the tractor and pump due to embankments sloping backwards or net downward pull forces of the pump. The chock according to an embodiment can be hydraulically deployed and will attempt to sink into ground on a backward motion hence resisting rolling.

It is another objective of the present invention to provide a PTO driven trailer turbine pump with a wheeled chassis connected to the frame. The adjustable wheel axle of the wheeled chassis can be adjusted for ground clearance during transport for rough, tracked (when wheel paths are sunken below normal ground level) or uneven terrain and for kneeling for increased submergence in lower water levels. The wheel axle may be adjustable hydraulically or manually.

Various objects, features, aspects and advantages of the present invention will become more apparent from the following detailed description of the embodiments of the invention, along with the accompanying drawings in which like numerals represent like components.

### BRIEF DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 shows a power take-off (PTO) driven trailer pump connected to a farm tractor using an adjustable hitch tongue for transportation.

FIG. 2 shows a partial cross sectional side view of the PTO driven trailer pump, according to an embodiment of the present invention.

FIG. 3 shows a side view of the PTO driven trailer pump with a wheeled chassis in lowered position, according to an embodiment of the present invention.

FIG. 4 shows a side perspective view of the PTO driven trailer pump with the wheeled chassis in raised position, according to an embodiment of the present invention.

FIG. 5 shows a back view of the PTO driven trailer pump, according to an embodiment of the present invention.

FIGS. 6 and 7 shows a top view and a bottom view of the PTO driven trailer pump respectively, according to an embodiment of the present invention.

FIGS. 8 and 9 shows sectional side views of the PTO driven trailer pump respectively, according to an embodiment of the present invention.

FIG. 10 shows a partial cross sectional side view of the PTO driven trailer pump with an angulated drive shaft shown forming an angle.

FIG. 11 shows a close up view of section ‘A’ marked in FIG. 10.

FIG. 12 shows the PTO driven trailer pump of the present invention in use.

FIGS. 13 and 14 are top views of the PTO driven trailer pump showing sidewise movement of a delivery pipe of the trailer pump, according to an embodiment of the present invention.

FIGS. 15 and 16 are front views of the PTO driven trailer pump showing vertical movement of the delivery pipe of the trailer pump, according to an embodiment of the present invention.

FIG. 17 is a sectional view of the PTO driven trailer pump showing hydraulically controlled adjustable arm adapted for moving and stabilizing the delivery pipe in sidewise direction.

FIG. 18 is a sectional view of the PTO driven trailer pump showing a close up view of an adjustable hitch tongue that connects the pump to the tractor's hitch for transportation.

FIG. 19 is a sectional view of the PTO driven trailer pump showing a jack stand and chock.

FIGS. 20-21 shows sectional side views of the PTO driven trailer pump demonstrating the movement of the hydraulically controlled adjustable arm, according to an embodiment of the present invention.

### DETAILED DESCRIPTION OF THE PREFERRED EMBODIMENT

The best mode and other alternative modes for carrying out the present disclosure is presented in terms of the embodiments herein. The embodiments described herein comprise detail used for illustrative purposes and are subject to many variations. The disclosed embodiments are merely exemplary. It is understood that various omissions and substitutions of equivalents are contemplated as circumstances may suggest or render expedient, but are intended to cover the application or implementation without departing from the spirit or scope of the present disclosure. Further, it is to be understood that the phraseology and terminology employed herein are for the purpose of the description and should not be regarded as limiting.

Further, the words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

The subject invention is directed to a power take-off driven trailered turbine pump that can be used in irrigation, flood control and various other uses where a high volume of material (such as water, slurry) needs to be moved from a source (such as canals, ditches, rivers, ponds) to another desired location. The same would be described in the description to follow.

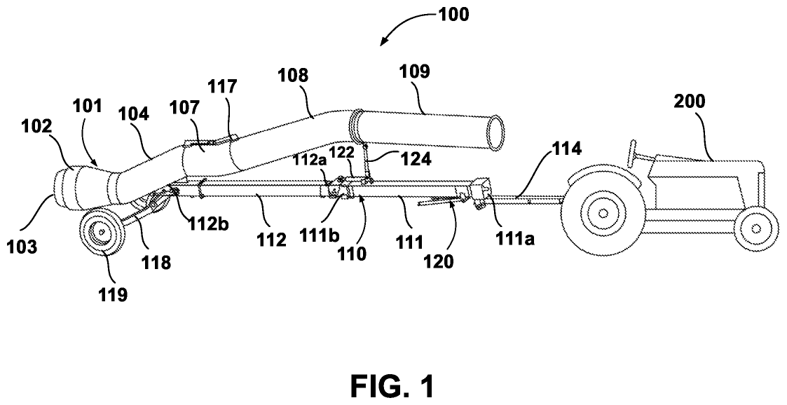

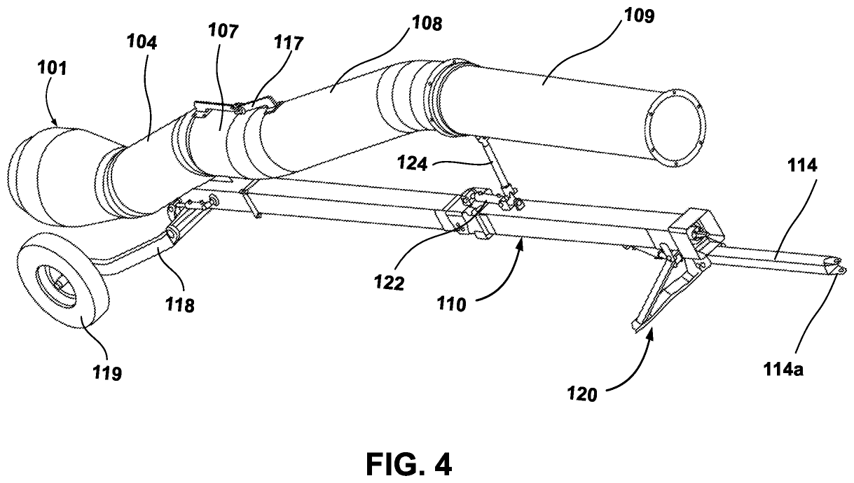

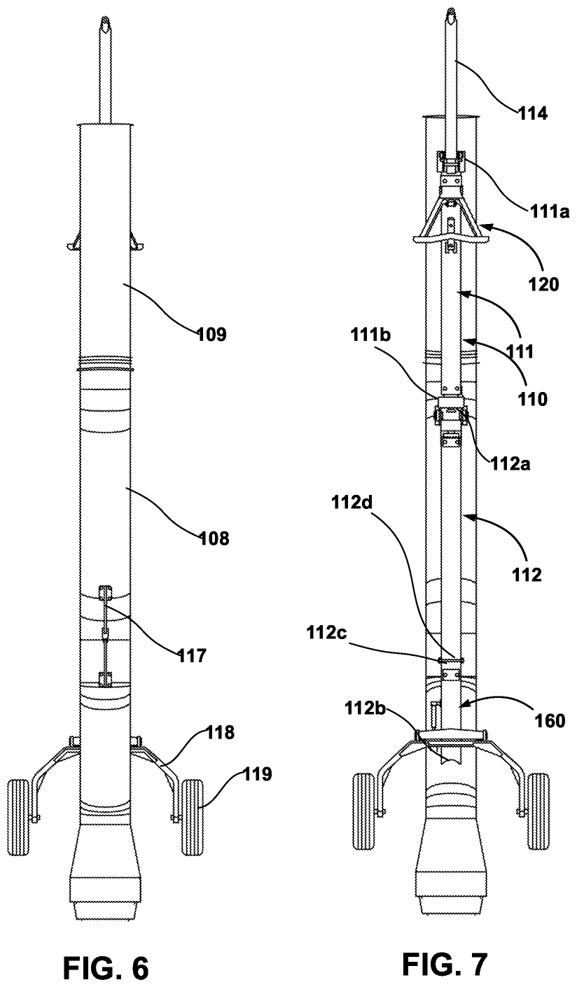

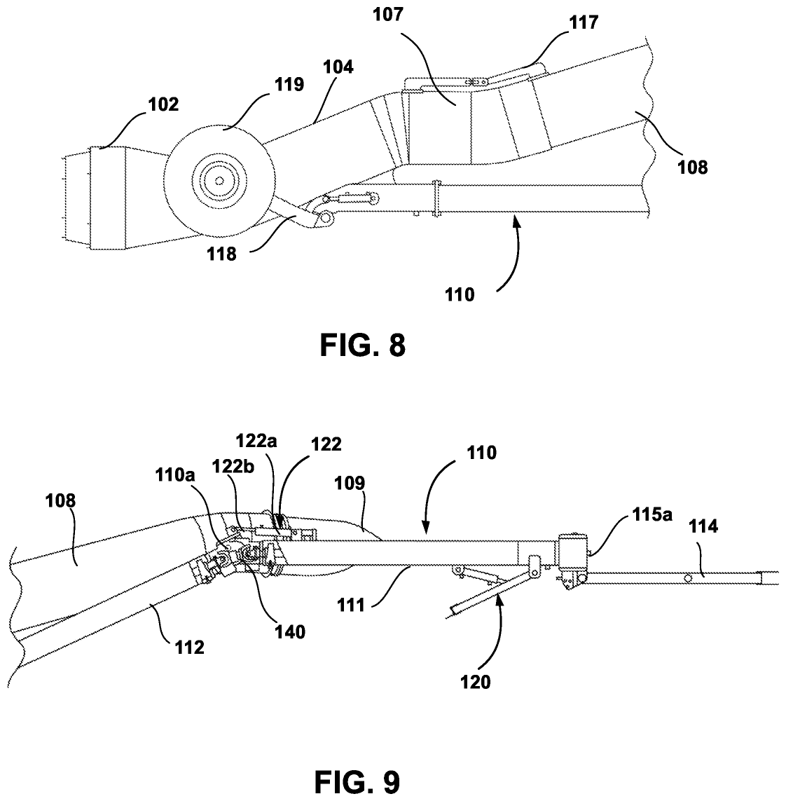

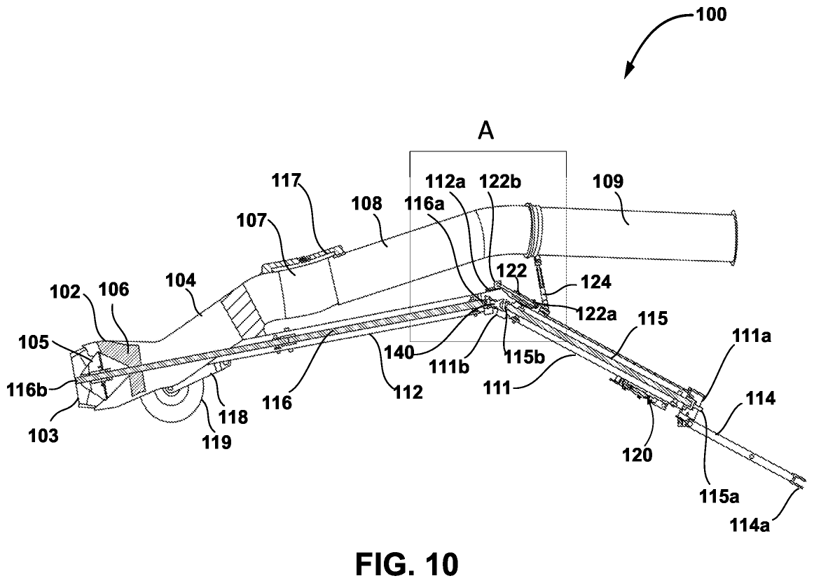

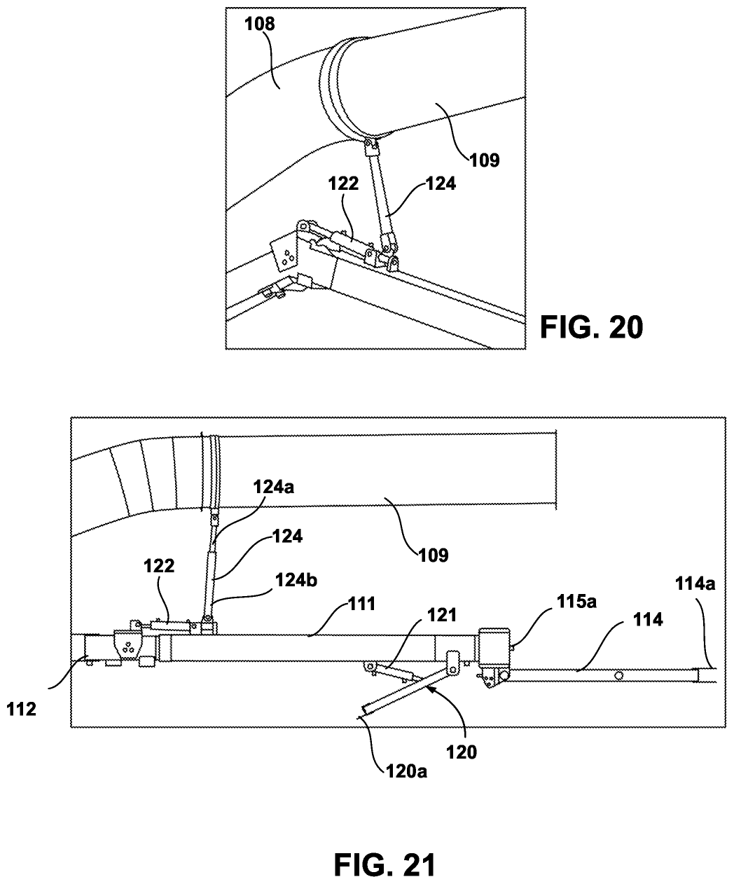

The various features and embodiments of a power take-off driven trailered turbine or centrifugal pump will now be described in conjunction with the accompanying figures, namely FIGS. 1-21.

Referring to accompanying figures and in particular to FIGS. 1-7, the preferred embodiment of the power take-off (PTO) driven trailer pump of the present invention designated by numeral 100 is shown. The proposed trailer pump 100 includes a pump housing 101. The pump housing 101 comprises a body portion 102, at least one inlet 103, and an outlet 104. The pump housing 101 further embodies a rotary impeller 105 with a vaned diffuser 106 disposed therein. According to the embodiment, a mixed flow impeller 105 with a plurality of circumferentially spaced vanes 106 is configured inside the pump housing 101 for enabling the pumping action by the pump 100. The mixed flow centrifugal impeller 105 with the vaned diffuser 106 provides a wider range of flow rates and pressures for the fluid passing there through and superior performance. This type of impeller 105 with vaned diffuser 106 permits mixed or diagonal flow of the fluid. It should be understood that the implementation of the present invention is not limited to just the use of the mixed flow type impeller and one can use other impeller types such as a radial impeller or an axial impeller.

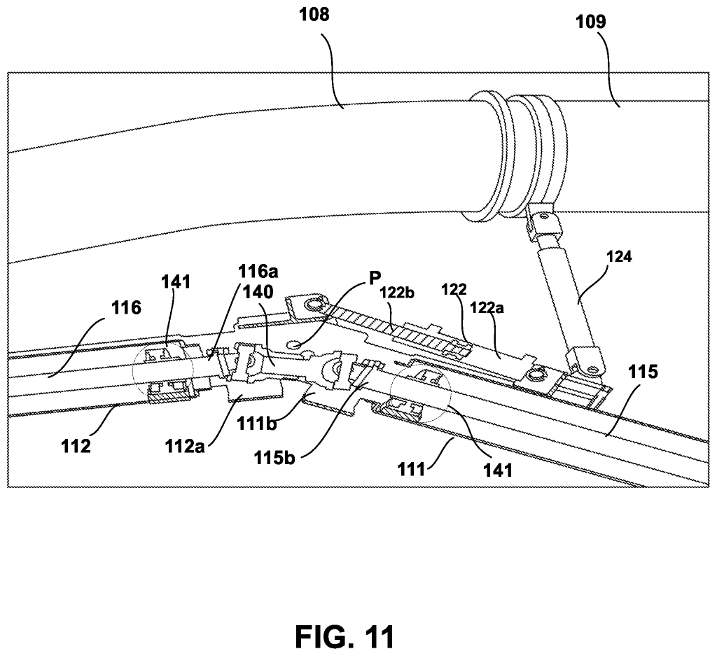

The trailer pump 100 further includes an elongated frame 110 embodying a drive shaft 113. The drive shaft 113 includes a first portion 115 and a second portion 116. The pump housing 101 is disposed at one end of the frame 110. The other end of the frame 110 is provided with an adjustable hitch tongue 114. The elongated frame 110 includes a first section 111 and a second section 112. The first section 111 includes a first end 111a and a second end 111b. The second section 112 includes a first end 112a and a second end 112b. The first section 111 of the frame 110 embodies the first portion 115 of the drive shaft 113. The second section 112 of the frame 110 embodies the second portion 116 of the drive shaft 113. The second end 111b of the first section 111 of the frame 110 is connected or coupled to the first end 112a of the second section 112 of the frame 110 such as to allow rotatory motion in relation to each other. The connection may preferably be a pivotal connection designated by ‘P’ (as shown in FIG. 11). The connected joint between the first end 112a of the second section 112 of the frame 110 is pivoted with two center pins (110a as shown in FIG. 9) and acts as an articulated joint that offers a limited angular motion of about 30-40 degrees from horizontal position between the first end 112a of the second section 112.

The first portion 115 of the drive shaft 113 includes a first end 115a and a second end 115b. The second portion 116 of the drive shaft 113 includes a first end 116a and a second end 116b. The first end 115a of the first portion 115 of the drive shaft 113 is mechanically connected to a power take-off unit (not seen) of a tractor 200. Typically the mechanical connection is a PTO spline connection. The first end 115a is identical to spline type found on the PTO output of the tractor 200. The mechanical power derived from the PTO unit of the tractor 200 rotate the drive shaft 113 which in turn rotate the impeller 105. The second end 115b of the first portion 115 of the drive shaft 113 is mechanically coupled to the first end 116a of the second portion 116 of the drive shaft 113. According to the embodiment, this mechanical coupling is achieved by using a universal joint 140. The universal joint 140 enables an articulated joint connection between the second end of the 115b of the first portion 115 of the drive shaft 113 and the first end 116a of the second portion 116 of the drive shaft 113. The rotatory motion between the first portion 115 and the second portion 116 at the universal joint 140 can be manually controlled (using human effort) or automatically controlled. The drive shaft 113 has constant rotary motion via the universal join 140. By adjusting the articulated joint “P” (seen in FIG. 11) of the frame 110 manually or hydraulically via drawbar or hydraulic actuator, the universal rotary shaft joint 140 may be controlled accordingly as the portions 115, 116 of the drive shaft 113 are constrained to the articulated frame 110 via pillow bearings 141 (shown in FIG. 11) of the universal joint 140. According to the embodiment, an actuator 122 is provided to control the angular movement and position of the frame sections 111, 112, at center pins of pivotal point “P”. Since the drive shaft portions 115, 116, and universal joint 140 are constrained via the bearings 141 to the frame 100, the rotary motion and torque is allowed to be transferred from shaft 115 to shaft 116 via the universal joint 140 at various angles of articulation of “P”. The actuator 122 may comprise a hydraulic actuator, an electric actuator and/or a pneumatic actuator. According to the embodiment presented herein, the actuator 122 is preferably a hydraulic cylinder that generates a unidirectional force through a unidirectional stroke. As known in the art, the hydraulic cylinder (such as the hydraulic cylinder 122) typically consists of a cylinder barrel 122a, in which a piston 122b connected to a piston rod moves back and forth increasing or decreasing the drive angle between the first portion 115 and the second portion 116 of the drive shaft 113 at the universal joint 140 or pivotal motion between the first section 111 and the second section 112 of the frame 110 at the pivotal point ‘P’. This angular adjustability between the two sections 111 and 112 of the frame 110 and the two portions 115, 116 of the drive shaft 113 is simultaneous and facilitates the trailer pump 100 to maneuver varying embankments and river beds for partially or fully submersing the pump housing 101 into the sumps, pond or other sources from where the fluid needs to be pumped out while allowing maximum power and torque to be transmitted and transferred

The power take-off driven trailer pump 100 is further provided with a chassis 118 and a pair of wheels 119. The wheels 119 are preferably inflatable tires. As seen, each of the wheels 119 is connected at two ends of the chassis 118. For the sake of brevity and as well known in the art, the way the wheels 119 would be connected to the chassis 118 (such as using axle) is not described herein. The wheeled chassis 118 is then connected to the frame 110 (at the second section 112 of the frame) using suitable coupling techniques known in the art such as but not limited to welding. According to the embodiment, the wheeled chassis 118 is preferably a hydraulically (using hydraulic cylinder 118a seen in FIG. 3) or manually controlled wheeled chassis for raising and lowering the pump housing 101 to increase or decrease ground clearance for easy convenient transportation of the trailer pump over various terrains. In other words, the wheeled axle chassis 118 is adjustable (hydraulically or manually) for adjustable ground clearance during transport for rough, tracked (when wheel paths are sunken below normal ground level) or uneven terrain and for kneeling for increased submergence in lower water levels. The axle chassis 118 is designed in the “c-shape” arrangement to eliminate the typical straight axle connecting both wheels in center which effectively reduces ground clearance to wheel radius.

According to the embodiment, the power take-off driven trailer pump 100 further includes one or more delivery pipes/tubes 108, 109 connected to the outlet 104 of the pump housing 101 using a flexible rubber joint 107, and a movable joining arm 117. The flexible rubber joint 107 may comprise a flexible pipe of substantially same dimension as that of the outlet 104 and the discharge pipe 108, 109. The joining arm 117 and flexible rubber joint 107 are configured to allow multi-directional discharge of the fluid through the delivery pipes 108, 109. Although, two discharge pipes 108, 109 are shown interconnected and then connected to the outlet 104 using the flexible rubber joint 107, it should be understood that any number of discharge pipes can be connected to the outlet 104. The discharge pipes 108, 109 are preferably of the same dimension as that of the outlet 104. Connecting one or more discharge pipes 108, 109 increases overall length of the outlet 104 and guide the fluid coming out of the outlet 104 to the desired direction.

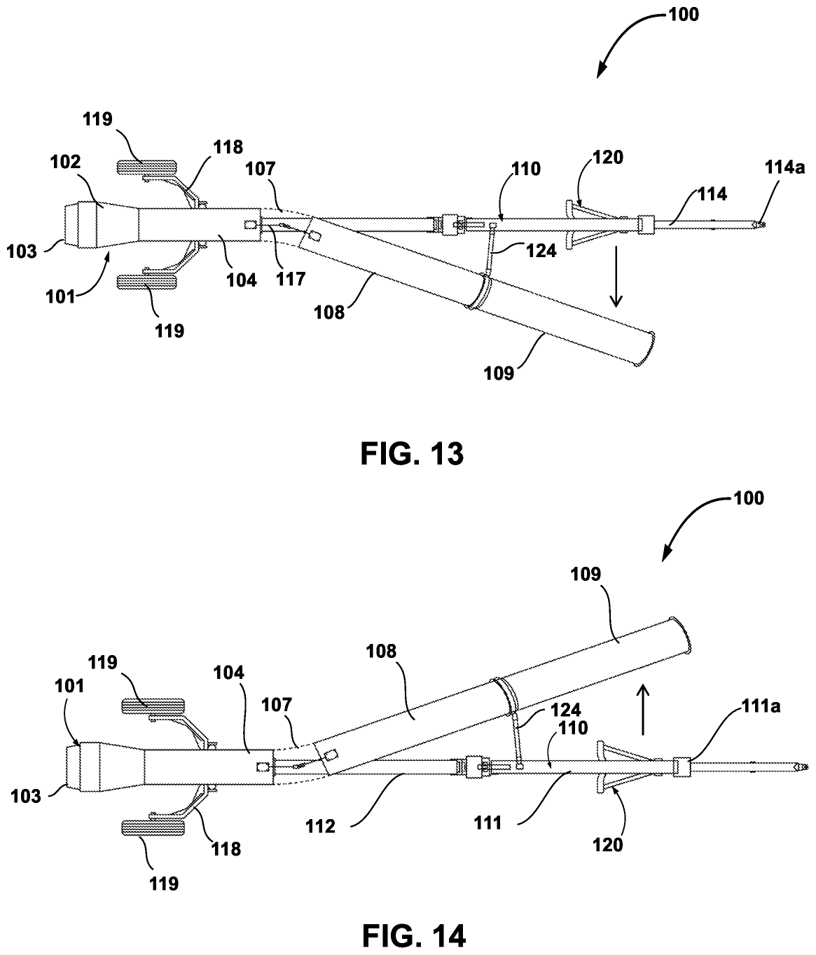

The multi-directional movement of the discharge pipe is shown in FIGS. 13-17.

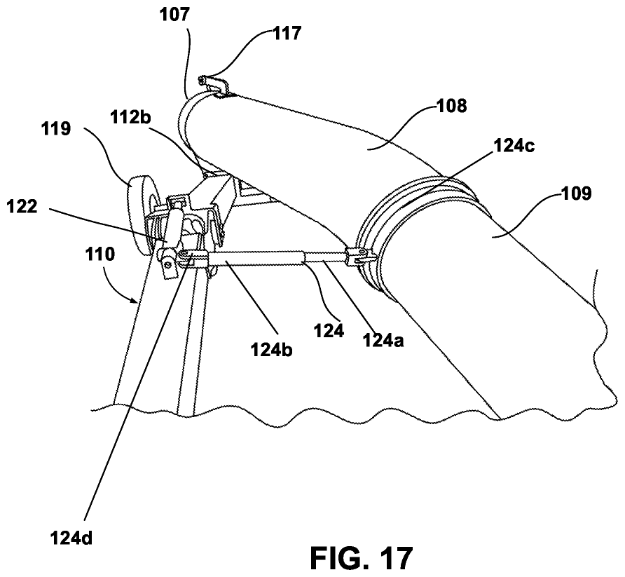

Particularly, FIG. 13 shows right side movement of the discharge pipe 108, 109 and FIG. 14 shows left side movement of the discharge pipe 108, 109. The direction of the discharge pipe 108, 109 can be changed to the right side or left side using an actuator 124 interconnecting the discharge pipe 108, 109 to the frame 110 particularly the first section 111 of the frame 110. The actuator 124 is connected to the discharge pipe 108, 109 using a connecting member 124c (as seen in FIG. 17) that holds the pipes 108, 109. In the embodiment as shown, the connecting member 124c is ring shaped. The actuator 124 at its other end is connected to the frame 110 using a hinge coupling 124d. The actuator 124 may be a hydraulic actuator, electric actuator and the like. According to the preferred embodiment, the actuator 124 is a hydraulic cylinder that can extend and retract hydraulically to move the discharge pipe 108, 109. In some other embodiment, instead of hydraulic arrangement, the discharge pipe 108, 109 can be moved manually using human effort. The actuator 124 is adapted to increase or decrease distance of discharge pipe 108, 109 from the frame 110. The arm 124 may preferably be in a hydraulic cylinder form to automatically push out or pull in the discharge pipe 108, 109. Because of pinned constraint of the hinge coupling 124d to the frame 110 and the connecting member 124c free to rotate about axis of the discharge pipe 108, 109. The adjustable arm 124 can only have angular/rotary motion at axis of the hinge coupling 124d controllable by a hydraulic rotary actuator or manually. In operation, the operator of the pump 100 or the tractor 200 may be provided with controls (in the form of switches for example) to move the discharge pipe 108, 109, when moved sidewise (as seen in FIGS. 13 and 14). During operation, a piston 124a of the hydraulic cylinder 124 is moved in or out of a barrel 124b pushing or pulling the discharge pipe 108, 109 away from or towards the frame 110, and to align the discharge pipes 108, 109 parallel to and above the frame 110 (as seen in FIG. 1), the arm 124 is rotated about axis of hinged coupling 124d automatically via rotary actuator or manually. The piston 124a moves to a particular desirable length and then stabilizes the discharge pipe 108, 109. During this rotary and left side and right side movements of the discharge pipe 108, 109, the flexible rubber joint 107 and the movable joining arm 117 aid in the process as seen in FIGS. 13 and 14. Particularly, flexibility of the flexible rubber joint 107 and the joint of the movable joint arm 117 help in changing the direction of the side movement of the discharge pipe 108, 109 sidewise.

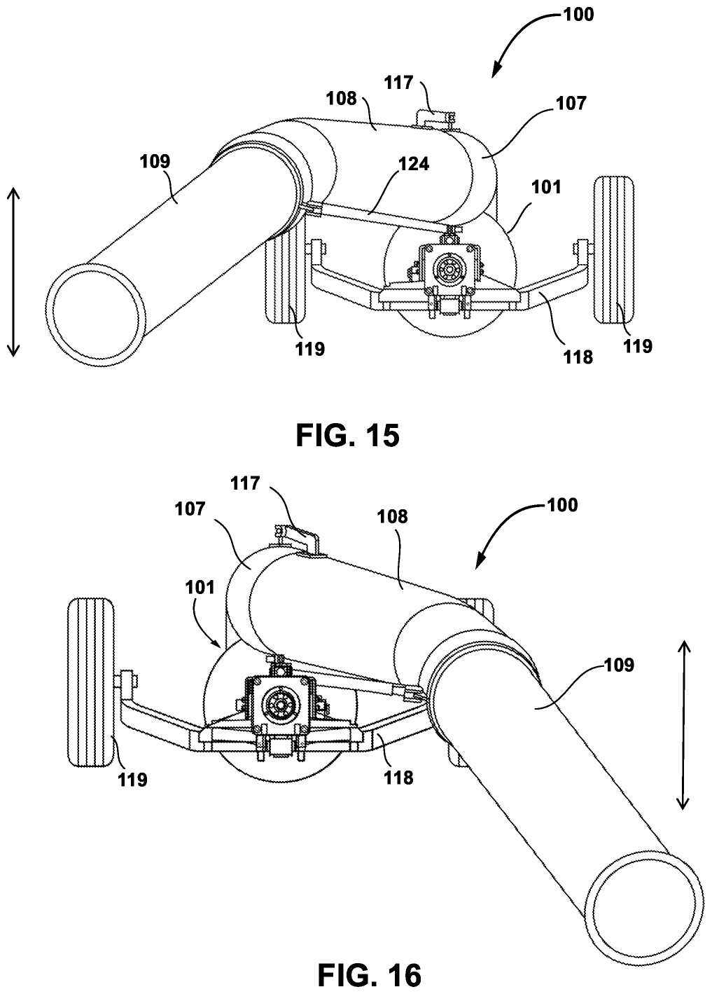

Next, FIGS. 15 and 16 shows up/down movement of the discharge pipe 108, 109 while the discharge pipe 108, 109 is moved onto the right side and left side, respectively. This directional change is facilitated by the movement of the actuator 124 and the flexible rubber joint 107 and the movable joining arm 117.

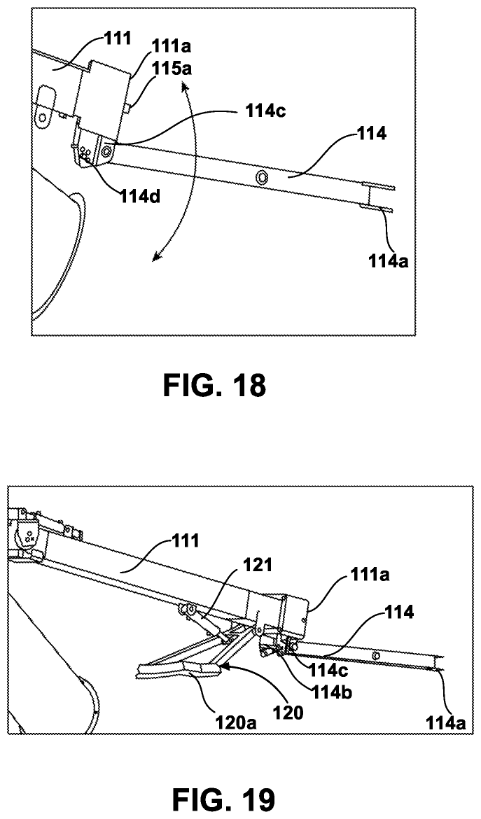

Referring to FIGS. 18 and 19, a sectional view of the PTO driven trailer pump showing a close up view of an adjustable hitch tongue that connects the pump to the tractor's hitch for transportation is shown. The adjustable hitch tongue 114 can be selectively adjusted based on the angle formed between the two sections 111 and 112 of the frame 110 or the two portions 115, 116 of the drive shaft 113. The adjustment of the hitch tongue 114 may be helpful while the trailer pump 100 maneuver embankments/river beds or the trailer pump 100 needs to be connected to the tractor 200 for transportation. Typically, the orientation of the frame 110 varies with respect to the tractor 200 depending upon if the tractor is 200 is simply towing the trailer pump 100 for transportation purpose or the tractor 200 is moved to submerge the pump 100 within deep ditches, sumps, concrete canals, ponds etc. The variation in the orientation of the frame 110 with respect to the tractor 200 is accounted by adjusting the hitch tongue 114. As seen in FIG. 18, one end of the adjustable hitch tongue 114 includes pair of plates with holes 114a that can be connected to the tractor's hitch (not seen) and then locked using a locking pin (not seen), and the other end of the adjustable hitch tongue 114 can be rotatably moved (as indicated by the double headed arrow) and locked using a pin 114b. As can be understood from FIGS. 18 and 19, the side plates 114c consists of a plurality of adjusting holes 114d through which the pin 114b is placed to support the hitch tongue 114 at certain angle. The pin 114b acts as a pivotal point that locks the tongue 114 at certain angle.

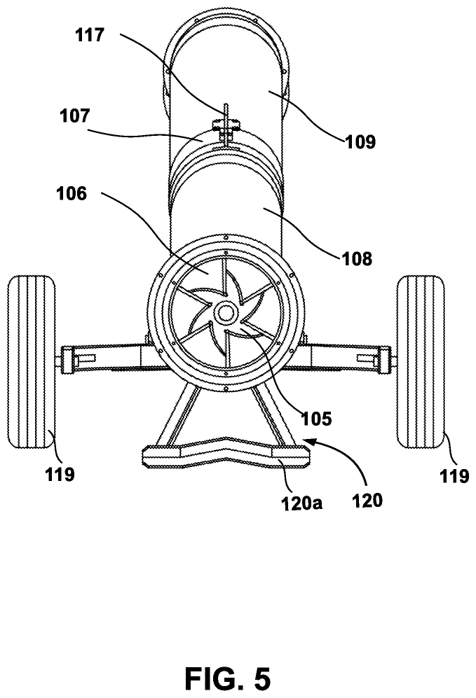

FIG. 19 also shows a jack stand and chock configured in the PTO driven trailer pump. The jack stand and chock is also seen in other figures such as FIGS. 5 and 21. The dual function jack stand and chock 120 is used to keep the pump or trailer 100 at definite height above ground when the trailer 100 is parked and for easy coupling of the tractor's hitch to the adjustable hitch tongue 114 of the pump 100. The jack stand 120 is foldable. The foldability can be implemented in a way to be operated manually or implemented using an actuator such as actuator 121. The actuator 121 may be a hydraulic actuator or electric actuator. According to the embodiment, the actuator 121 is hydraulic cylinder that can be operated using controls present in the tractor's cabin or controls mounted on the trailer pump 100. The base of the jack stand 120 includes a plate member 120a. Unlike the existing systems, this base plate 120a acts as a chock and assists in resisting backward motion or rolling of the tractor and pump due to embankments sloping backwards or net downward pull forces of the pump. The chock 120a according to an embodiment can be hydraulically deployed and will attempt to sink into ground on a backward motion or rolling

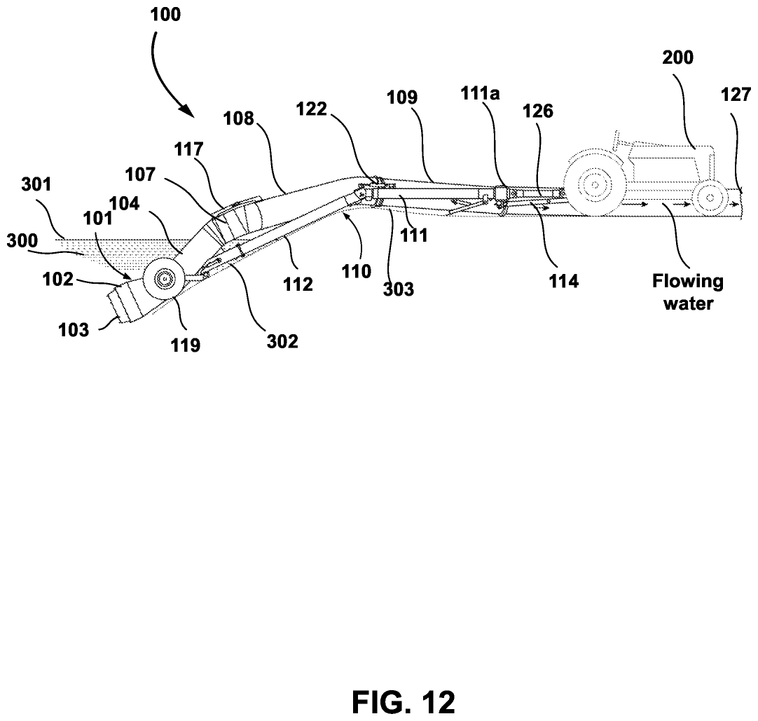

Referring to FIG. 12 shows the PTO driven trailer pump of the present invention in use. In the example shown, the PTO driven trailer pump 100 is shown in use pumping out water from a pond 300 for irrigation purpose. During use, the wheels 119, the pump housing 101 are submerged under the water surface 301 of the pond 300 or the like. In this orientation, water can flow from the pond 300 into the pump housing 101 via an inlet 103. The hitch tongue 114 connected to the end portion (the first end 111a of the first section 111) of the frame 110 is above the water surface 301 and connected to a tractor 200 (using tractor's hitch) and remains on dry land. As should also be understood the pump shaft 110 should also be connected to tractor side PTO using some additional shaft 126 (such as CARDAN drive shaft known in the art). Also, as needed, the operator can actuate controls for achieving desired angle between the two sections 111 and 112 of the frame 110 and the two portions 115, 116 of the drive shaft 113 so that the trailer pump 100 can maneuver varying embankments 303 and river beds 302 for partially or fully submersing the pump housing 101 into the pond or other sources from where the fluid needs to be pumped out.

During use, the operator (operator of the pump 100 or the driver of the tractor 200) powers the drive shaft 113 with the power take-off unit of tractor 200. For this, the end 115a of drive shaft 113 would be mechanically connected to PTO unit of the tractor 200 via a CARDAN drive shaft known in the art. Although, the present invention is designed to work using power from the power take-off unit of the tractor 200, it should be understood that the pump 100 may be self-driven with power source and related controls mounted on the trailer pump 100.

Once the operator powers the drive shaft 113, the drive shaft 113 rotates. The rotation of the drive shaft 113 results in a rotation of impeller 105. Centrifugal rotation of the impeller 105 result in water to get into the pump body 102 through one the inlet 103 of the pump 101 and then emerge out through an outlet 104. The water emerging or being pumped out through the outlet 104 then passes through the flexible rubber joint 107 and one or more delivery pipes 108, 109. Water coming out of the outlet 104 or the delivery pipe 108, 109 can either be directly used or routed to any other desired location (distant location) using an extended pipe 127 varying in length. The user can connect this extended pipe 127 of desired length to the delivery pipe 108, 109 for routing the pumped water from the pond 300 to the fields for irrigation.

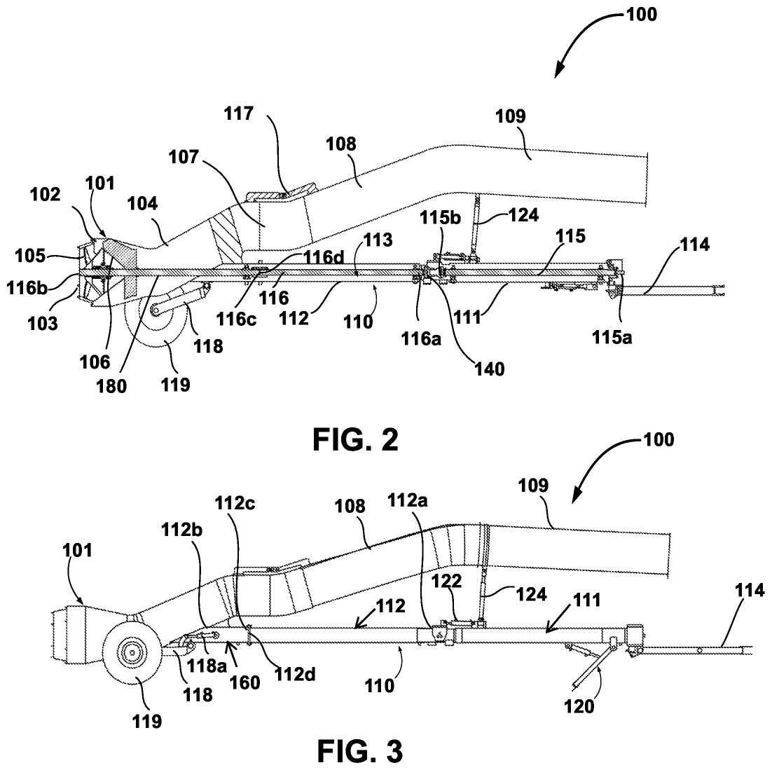

Although the above embodiments described considering the frame 110 to have two sections 111, 112 and the drive shaft 113 to have two portions 115,116, it should be noted that the frame 110 may include three sections 111, 112 and 160 (as shown in FIG. 3). and the drive shaft 113 may include three portions 115, 116, and 180 (as shown in FIG. 2). To elaborate, the section 112 may further be divided into two sections using an intermediate mechanical coupling shown as shown in FIG. 3 with the new section having a first end 112c and the second end as 112b, and the second portion 116 of the drive shaft 113 may be divided into two portions using an intermediate mechanical coupling shown in FIG. 2 with the new portion having a first end 116c and the second end as 116b.

It should be understood according to the preceding description of the present invention is susceptible to changes, modifications and adaptations, and that the said changes, modifications and adaptations fall within scope of the appended claims.

What is claimed is:

1. A power take-off driven trailer turbine pump (100), comprising:
a pump housing (101) having a body portion (102) with at least one inlet (103), an outlet (104), and an impeller (105) with a vaned diffuser (106) disposed within the pump housing (101);
a drive shaft (113) comprising a first portion (115) and a second portion (116);
an elongated frame (110) comprising a first section (111) and a second section (112), the first section (111) embodies the first portion (115), and the second section (112) embodies the second portion (116) of the drive shaft (113);
wherein,
a second end (111b) of the first section (111) is coupled to a first end (112a) of the second section (112) of the elongated frame (110), and a second end (115b) of the first portion (115) is coupled to a first end (116a) of the second portion (116) of the drive shaft (113) such as to facilitate angular adjustability between the first section (111) and second section (112) of the elongated frame (110), and between the first portion (115), and second portion (116) of the drive shaft (113) simultaneously; and
one or more delivery pipes (108, 109) connected to the outlet (104) of the pump housing (101) using a flexible rubber joint (107), and a movable joining arm (117), wherein the one or more delivery pipes (108, 109) are configured to have multi-directional movement.

2. The power take-off driven trailer pump (100) of claim 1, wherein the impeller (105) is a mixed flow impeller.

3. The power take-off driven trailer pump (100) of claim 1, wherein the angular adjustability between the first section (111) and second section (112) of the elongated frame (110), and between the first portion (115), and second portion (116) of the drive shaft (113) allows the power take-off driven trailer pump (100) to maneuver varying embankments and river beds for partially or fully submersing the pump housing (101).

4. The power take-off driven trailer pump (100) of claim 1, wherein the second end (111b) of the first section (111) is coupled to the first end (112a) of the second section (112) of the elongated frame (110) using a pivotal connection (P).

5. The power take-off driven trailer pump (100) of claim 1, wherein the second end (115b) of the first portion (115) is coupled to the first end (116a) of the second portion (116) of the drive shaft (113) using a universal joint (140).

6. The power take-off driven trailer pump (100) of claim 5, wherein the universal joint (140) between the second end (115b) of the first portion (115) and the first end (116a) of the second portion (116) of the drive shaft (113) is manipulated for angular adjustability using a first actuator (122).

7. The power take-off driven trailer pump (100) of claim 6, wherein the first actuator (122) is a hydraulic actuator, an electric actuator and/or a pneumatic actuator.

8. The power take-off driven trailer pump (100) of claim 5, wherein the universal joint (140) between the second end (115b) of the first portion (115) and the first end (116a) of the second portion (116) of the drive shaft (113) is manipulated manually using a manual screw adjusted drawbar.

9. The power take-off driven trailer pump (100) of claim 1, wherein the movable joining arm (117) and the flexible rubber joint (107) are configured to allow multi-directional movement to the delivery pipes (108, 109).

10. The power take-off driven trailer pump (100) of claim 1 further comprising a second actuator (124) interconnecting the discharge pipe (108, 109) to the elongated frame (110), wherein the second actuator (124) when operated facilitates in multi-directional movement of the delivery pipes (108, 109).

11. The power take-off driven trailer pump (100) of claim 10, wherein the second actuator 124 push or pull the delivery pipe (108, 109) and that a rotary actuator (not seen) swings the delivery pipe (108, 109) from right to left.

12. The power take-off driven trailer pump (100) of claim 10, wherein the second actuator (124) is a hydraulic cylinder that can extend and retract hydraulically to move the discharge pipe (108, 109).

13. The power take-off driven trailer pump (100) of claim 1, wherein the discharge pipe (108, 109) can be moved manually.

14. The power take-off driven trailer pump (100) of claim 1 further comprising a hitch tongue (114) selectively adjustable based on an angle resulted due to the angular adjustability between the first section (111) and second section (112) of the frame (110) and/or the first portion (115) and second portion (116) of the drive shaft (113).

15. The power take-off driven trailer pump (100) of claim 14, wherein the adjustment of the hitch tongue (114) assists the power take-off driven trailer pump (100) to maneuver embankments and river beds or connecting the power take-off driven trailer pump (100) to a tractor (200) for transportation.

16. The power take-off driven trailer pump (100) of claim 1 further comprising a foldable dual function jack stand and chock (120) used for:
keeping the power take-off driven trailer pump (100) at definite height above ground when the power take-off driven trailer pump (100) is parked and for easy coupling of the tractor's hitch to the adjustable hitch tongue (114); and
assisting in resisting backward motion or rolling of the tractor (200) and the pump (100) due to embankments sloping backwards or net downward pull forces of the pump (100).

17. The power take-off driven trailer pump (100) of claim 16, wherein the jack stand and chock (120) is foldable manually or hydraulically.

18. The power take-off driven trailer pump (100) of claim 1, wherein the flexible rubber joint (107) is a flexible pipe of substantially of same dimension as that of the outlet (104) and the discharge pipe (108, 109).

19. The power take-off driven trailer pump (100) of claim 1, wherein the drive shaft (113) is driven through a power take-off unit of the tractor (200) or self-driven using external power source attached onto the power take-off driven trailer pump (100).

20. The power take-off driven trailer pump (100) of claim 1 further comprising a hydraulically or manually controlled wheeled chassis (118,119) connected to the second section (112) of the elongated frame (110) for raising and lowering the pump (100) to increase or decrease ground clearance for easy convenient transportation over various terrain and for kneeling for increased submergence in lower water levels.
